(19) United States
(12) Patent Application Publication
(10) Pub. No.: US 2018/0066924 A1
(43) Pub. Date: Mar. 8, 2018

(54) HORIZONTALLY CONNECTING ARCHERY TARGET

(71) Applicant: Easton Technical Products, Inc., Salt Lake City, UT (US)

(72) Inventor: Sam J. Miller, Cedar Falls, IA (US)

(73) Assignee: Easton Technical Products, Inc., Salt Lake City, UT (US)

(21) Appl. No.: 15/260,128

(22) Filed: Sep. 8, 2016

(51) Int. Cl. F41J 3/00; F16B 2/00

(52) U.S. Cl. CPC F41J 3/0004; F16B 2/00

(57) ABSTRACT

Target assemblies and related methods for archery and other projectile shooting practice and training are disclosed. One target assembly has a first target body and a second target body that are respectively shaped as a lower portion and an upper portion of an animal. An elongated ridge on one of the target bodies is positioned within an elongated groove on the other target body. The first target body is positioned underneath the second target body with the front ends of the first and second target bodies being adjacent each other and with the rear ends of the first and second target bodies being adjacent each other. The target assemblies and related methods have improved stability, portability, and durability in comparison to conventional three-dimensional target assemblies.

### TECHNICAL FIELD

The present disclosure generally relates to targets for shooting practice, and the present disclosure specifically relates to a horizontally-connecting 3-dimensional archery target.

### BACKGROUND

Three-dimensional targets are often used by hunters and sportsmen to train and practice shooting, especially archery bows. The targets are often made to imitate the shape, size, and color of various game animals, such as deer, elk, and bear. Because their size makes them difficult to mold and transport in one piece, they are usually made in multiple parts or sections that are assembled together by the end user. When setting up the target, the user connects several interlocking parts of the animal shape together and then lifts the assembly and places it on stakes or a stand. The stakes or stand then keep the target upright in the target range where the shooter takes aim.

Conventional three-dimensional targets can be frustrating to assemble and move, such as when the target is placed on the stakes and stand. The target's parts are often made to slide together with dovetail or tongue-and-groove interlocking parts—commonly interlocked vertically with each other—such that the interface between the parts can fall apart or shift when the target is lifted, moved, or hit by projectiles. In some instances, an archer may brace or push on the target to withdraw arrows stuck in the target surface and thus put stress on the interfaces between the parts and/or cause them to shift and move relative to each other. Movement of the parts relative to each other can make the target fall apart or appear ragged.

The interfaces between parts also tend to deteriorate over time due to aging or due to being damaged by arrows or other projectiles, thereby leading to brittleness and weakness of the tongue-and-groove features. Deterioration shortens the lifespan of the target and causes frustration to the user, who has to constantly rebuild the target when it falls apart under normal use. Additionally, most three-dimensional targets are made up of several (e.g., as many as four or more) large and bulky parts, and users find it unwieldy and inconvenient to have to keep all of the parts assembled while they are moved and set up at a shooting range.

As a result, there is a need for improvements to three-dimensional targets used for training and practice in archery and other types of shooting.

### SUMMARY

One aspect of the present disclosure relates to an archery target assembly, which may comprise a first target body having a first width, a second target body having a second width, a bottom portion, and a target surface. The first target body may contact the bottom portion of the second target body, and the first and second widths may be about equal to each other, with the first target body being slidably separable from the second target body along a horizontal direction.

In some embodiments, the first and second target bodies may be connected to each other using an elongated ridge engaging an elongated groove, wherein the elongated ridge and elongated groove are each elongated in the horizontal direction. The elongated ridge and the elongated groove may each comprise a T-shaped cross-section.

The first target body may comprise a first material and the second target body may comprise a second material, with the second material being more flexible than the first material. The target assembly may also comprise a rod, wherein the rod may be connected to the first target body and may be configured to keep the first target body upright. The first and second widths may be horizontally-oriented when the archery target assembly is in an upright position. The first and second target bodies may be press-fit into engagement with each other. At least one of the first and second target bodies may be compressed against the other. The target assembly may also further comprise a third target body, wherein the third target body is attached to a side or top portion of the second target body.

In another aspect of the disclosure, an archery target assembly comprises a first target body shaped as a lower portion of an animal, with the first target body having a front end, a rear end, and an elongated ridge extending between the front end and the rear end. A second target body shaped as an upper portion of the animal may also be included, with the second target body having a front end, a rear end, and an elongated groove extending between the front end and the rear end. The first target body may be positioned underneath the second target body, with the front ends of the first and second target bodies being adjacent each other, the rear ends of the first and second target bodies being adjacent each other, and the elongated ridge being positioned within the elongated groove.

The elongated groove and the elongated ridge may be configured to extend in a substantially horizontal direction. The elongated groove and elongated ridge may each have a length extending substantially from the front end to the rear end of the first and second target bodies. The elongated ridge may comprise a vertical ridge portion and a horizontal ridge portion, and the elongated groove may comprise a vertical groove portion and a horizontal groove portion. The vertical ridge portion may be positioned in the vertical groove portion, and the horizontal ridge portion may be positioned in the horizontal groove portion. At least one of the elongated ridge and the elongated groove may be tapered along the horizontal direction. The elongated groove may be open from the horizontal direction at the front end of the second target body, and the elongated groove may be closed from the horizontal direction at the rear end of the second target body.

Yet another aspect of the disclosure relates to a method of constructing an archery target. The method may comprise providing a first target body, a second target body, and a stand. The first target body may have a first length and an elongated ridge, and the second target body may have a second length and an elongated groove. The first and second lengths may be substantially equal, with the elongated ridge having a ridge length substantially equal to the first length, and the elongated groove having a groove length substantially equal to the second length. The method may also include inserting the elongated ridge on the first target body into the elongated groove on the second target body and positioning the first and second target bodies upright, wherein at least one of the first and second target bodies is positioned on the stand, and the first and second target bodies are vertically stacked on each other above the stand.

In some embodiments, the elongated ridge is inserted into the elongated groove in a horizontal direction. The stand may be mounted to a ground surface. The method may also include compressing at least one of the elongated ridge and the elongated groove while inserting the elongated ridge on the first target body into the elongated groove on the second target body. In another embodiment, the method includes lifting at least one of the first and second target bodies with the first and second target bodies being positioned upright, wherein the elongated groove and elongated ridge remain stationary relative to each other while lifting. Yet another method may comprise attaching a third target body to one of the first and second target bodies, with the third target body extending vertically higher than the first and second target bodies.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a perspective view of a target assembly according to an embodiment of the present disclosure.

FIG. 2 is an exploded view of a target assembly according to the present disclosure.

FIG. 3 is a side view of a leg portion of the target assembly of FIG. 1.

FIG. 4 is a rear end view of the leg portion of FIG. 3.

FIG. 5 a top view of the leg portion of FIG. 3, as indicated by lines 5-5 in FIG. 3.

FIG. 6 is a top section view of the leg portion of FIG. 3 taken through section lines 6-6 in FIG. 3.

FIG. 7 is a side section view of a body portion of the target assembly of FIG. 1 taken through section lines 7-7 in FIG. 8.

FIG. 8 is a front view of the body portion of FIG. 7.

FIG. 9 is a bottom view of the body portion of FIG. 7, as indicated by lines 9-9 in FIG. 8.

FIG. 10 is a bottom section view of the body portion of FIG. 7 taken through section lines 10-10 of FIG. 8.

FIG. 11 is a detail exploded perspective view of the target assembly of FIG. 1.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to archery target assemblies and related methods that provide improved ease of assembly, durability, and stability over existing three-dimensional (3D) targets. While the targets are generally intended for archery, they may also be used as firearm targets. In an example embodiment, the target assembly comprises at least two target bodies. The two target bodies may have about the same horizontal width, and one may be positioned on top of the other. The target bodies may be slidably connectable and separable from each other along a horizontal direction.

Other three-dimensional targets may comprise parts that are horizontally slidable relative to each other, but those parts do not have equal widths. For example, other targets may have one part that is a leg portion of an animal and another part that is the trunk or torso portion of the animal. Thus, there is only a small contact surface between the leg and torso portions, and any connection interface between them is similarly small. Such small connection interfaces are more likely fail due to aging, deterioration, damage, and general handling of the parts, but these drawbacks are reduced when the first and second portions of the target have about equal width and are positioned stacked vertically on top of each other.

In some embodiments, the first and second target bodies may be connected to each other to prevent the assembled target from falling apart when moved, touched, or struck by a projectile. The first and second target bodies may be connected to each other using an elongated ridge engaging an elongated groove. The ridge and groove may be elongated horizontally, and the first and second target bodies may be assembled together by horizontally sliding the ridge into an open end of the groove. In some cases, the ridge and groove may have substantially T-shaped cross-sections that fit within each other. The ridge and groove may also extend along a substantial length of each of the first and second target bodies. For example, each of the ridge and groove may extend along substantially the entire length the target body to which each one is formed. Thus, the connection between the first and second target bodies may extend along substantially the entire length of both of the target bodies. In such arrangements, the target assembly may remain securely assembled even if there is damage or deterioration of portions of the ridge or groove since the large size of the connection allows other, undamaged portions of the interface to maintain the integrity of the rest of the connection.

The ridge and groove may comprise a tongue-and-groove or dovetail configuration wherein they interlock when connected to each other so that they cannot be pulled apart in a direction perpendicular to the direction of their elongation, but that they can be separated by sliding apart in a direction parallel the direction of their elongation. As used herein, two parts may be “slidable” relative to each other if they have surfaces that slide along each other while they are in contact with each other.

The target assembly may be formed in a shape of an animal, such as, for example, a game animal. The shape may be three-dimensional and may approximate the features of the animal. For example, one part of the target assembly may correspond to the legs and belly portion of a deer, elk, antelope, bear, sheep, goat, large feline, or other animal, and another part of the target assembly may correspond to the haunches, shoulders, and back of the animal spaced vertically above the lower leg and belly portion. Thus, the horizontal connection between the parts may extend horizontally through a torso section of the animal shape where there is more space for a connection between parts than at an interface between other areas on an animal. For example, the horizontal connection across the torso may be greater in length and girth than a horizontal connection across a knee, thigh, neck, or other part of the animal shape. A head shape may be formed with the torso or added thereto as a separate piece.

The target assembly may also comprise stakes or a stand used to keep the assembly upright. For example, stakes may be planted in the earth or may be attached to a base that provides stability to the target assembly while it is positioned upright. As used in the present application, a target assembly is “upright” when it is positioned with the horizontal connection between target bodies oriented in a horizontal direction relative to a gravitational direction (e.g., substantially parallel to flat ground) and the target shape is in a standing position (e.g., in an orientation intended to be supported by a stand or stakes while it is shot). For example, a three-dimensional target of a standing deer would be considered upright when it is positioned with its legs substantially extending in a gravitational direction downward toward the ground and its back is substantially horizontal (i.e., substantially parallel to the ground), and it would not be considered upright if it was turned 90 degrees sideways with its legs extending horizontally and its back extending along a vertically upward direction. Similarly, a three-dimensional target of a bedded deer would be considered upright when it is positioned with its belly beneath its back relative to a vertical gravitational direction.

Some existing three-dimensional targets comprise animal shapes that have vertical divisions between a front half of the animal shape's torso (i.e., the shoulders and chest area) and a rear half (i.e., the haunches and tail area), but those front-rear divided parts are not considered “upright” when their front half is positioned on top of the rear half because they are not stable in that position, they are not intended to be positioned in that manner when they are used as targets (e.g., they do not come with a stand or stake retaining openings that would keep them in that position), and they do not look like a natural, live animal in that orientation.

As used herein, a “lower portion” of an animal shape refers to the animal's lower body that is a portion of the animal below a horizontal line drawn through the animal's shape when it is upright. The “upper portion” of an animal shape refers to the animal's upper body that is a portion of the animal above the horizontal line drawn through the animal's shape when it is upright.

The target assembly may be held together using various different interface features. In some embodiments, the target assembly may have a ridge and a groove, wherein at least one of the ridge and groove is compressed or friction-fit into the other. The material of one of the target parts may be different from the material used in another of the parts, such as, for example, one part being more flexible, tear-resistant, or compressible than the other. In some embodiments, the ridge and groove may be tapered in a complementary manner to increase the amount of their surface areas that engage each other.

The horizontal connection interface between the major parts of the target assemblies of the present disclosure may also help to make the target assemblies easier to carry, move, reposition, and reset after shooting. The horizontal interface is assisted by gravity rather than being hindered by gravity, as is the case in various vertically-separated target assemblies. The horizontal interface also reduces the number of parts in the target assembly, so there are fewer to manage and reset if they do shift. Also, the act of pressing against the target assembly to withdraw arrows is less likely to cause the parts to shift. Thus, the target assemblies are more stable and convenient to use.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

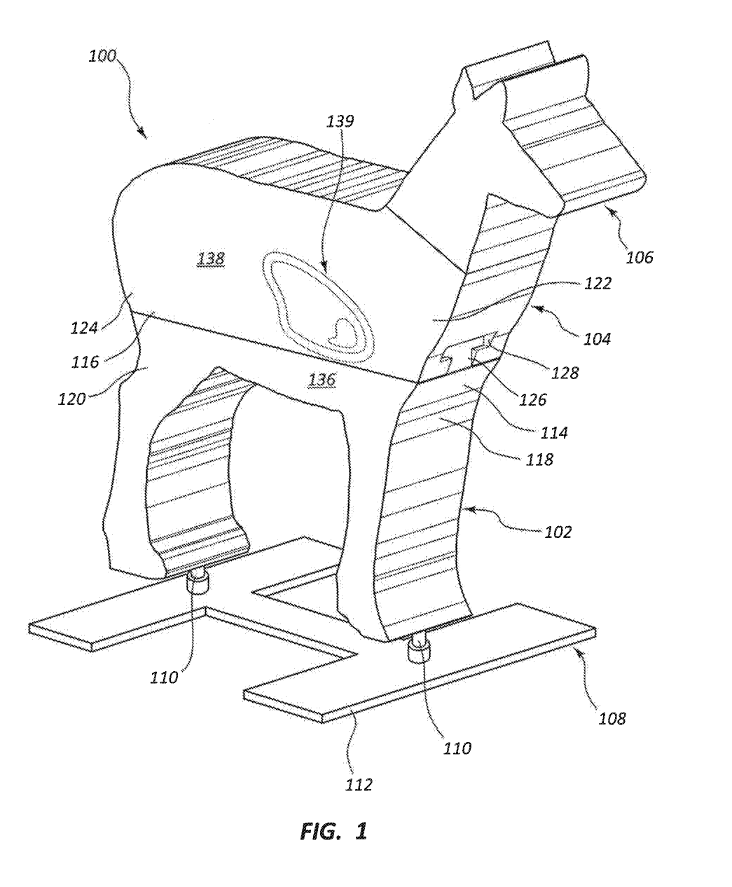

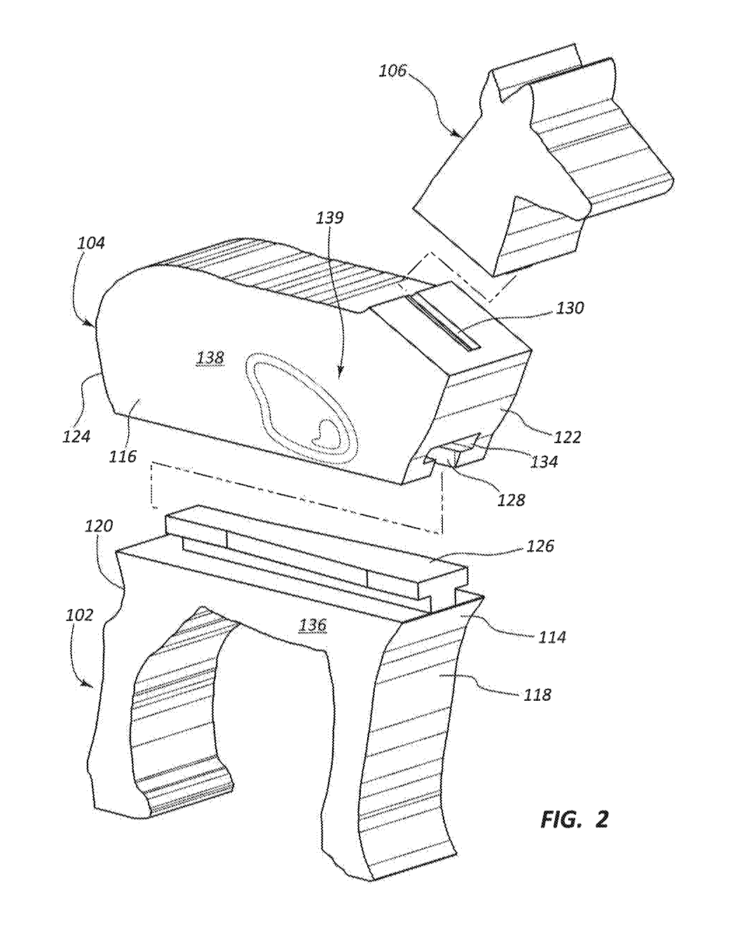

Turning now to the figures in detail, FIGS. 1-2 show views of a target assembly 100 according to the present disclosure. FIG. 1 shows the target assembly 100 fully assembled, and FIG. 2 shows an exploded view thereof. The target assembly 100 may comprise a first target body 102, a second target body 104, a third target body 106, and a stand 108. For convenient reference herein, the first target body 102 may alternatively be referred to as a lower portion or leg portion of the target assembly 100, the second target body 104 may alternatively be referred to as a middle portion, upper portion, or body portion of the target assembly 100, and the third target body 106 may be referred to as a head portion of the target assembly 100. However, the shapes of the first, second, and third target bodies need not necessarily resemble legs, bodies, and heads, respectively, in some embodiments.

The leg portion 102 may be connected to the stand 108. For example, the leg portion 102 may comprise openings or rings (not shown) that receive stakes or poles 110 from the stand 108. The stakes or poles 110 from the stand 108 may extend vertically upward from a base portion of the stand 108 or from the ground around the target assembly 100. The base portion 112 may extend horizontally away from the stakes or poles 110 to provide stability to the target assembly 100.

The leg portion 102, body portion 104, and head portion 106 may each comprise different materials. For example, the body portion 104 may comprise a material that is softer, less rigid, more durable, and more tear-resistant than material used in the leg portion 102 and head portion 106. Thus, the body portion 104 may be better suited to receive and withstand repeated penetrations from arrow points and other projectiles in and around the target surface 139, and the leg portion 102 and head portion 106 may be well-suited to provide stability and a predetermined form to the target assembly 100.

A top end portion 114 of the leg portion 102 may connect to a bottom end portion 116 of the body portion 104. The leg portion 102 may comprise a front end portion 118 and a rear end portion 120, and the body portion 104 may also comprise a front end portion 122 and a rear end portion 124. As used herein, reference to the terms “front” or “rear” of the target assembly 100 or its component parts is used for convenience in understanding the invention. Those having ordinary skill in the art will also know and recognize that the notation of the front and rear of the assembly may be reversed in some embodiments without departing from the spirit and letter of the present disclosure.

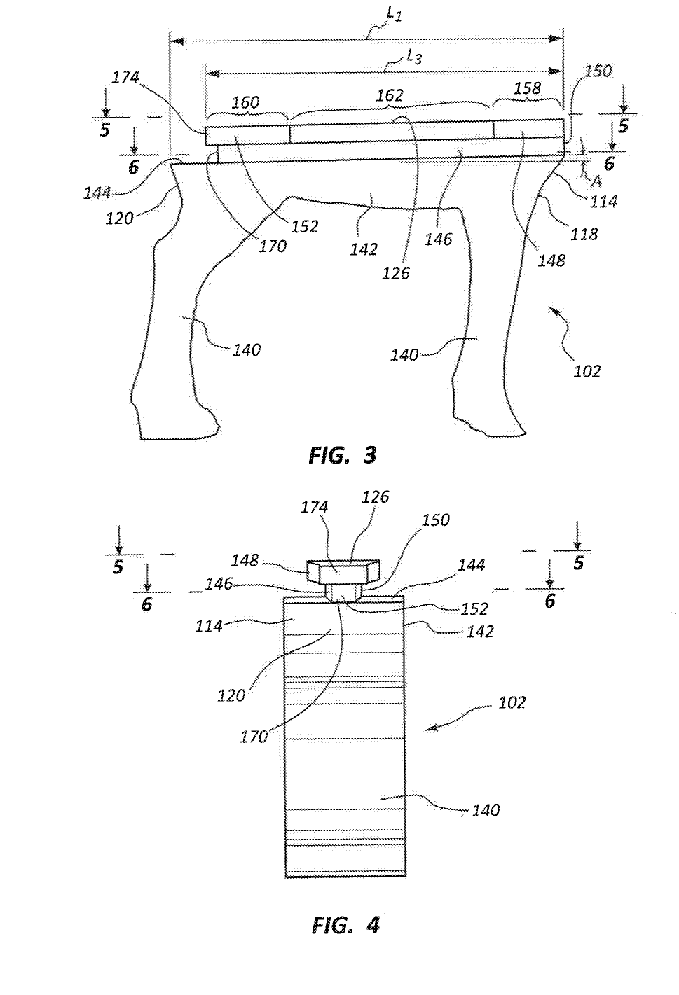

When assembled, the front end portion 118 of the leg portion 102 may be adjacent to the front end portion 122 of the body portion 104, and the rear end portion 120 of the leg portion 102 may be adjacent to the rear end portion 124 of the body portion 104. Accordingly, in some embodiments the front end portions 118, 122 may directly contact each other without any intervening parts or substances, and the rear end portions 120, 124 may also directly contact each other without any intervening parts or substances. Each of the leg and body portions 102, 104 may have substantially equal lengths, such as on the top or bottom surfaces of each of the portions 102, 104 that contact each other. See lengths L₁, L₂ in FIGS. 3 and 7.

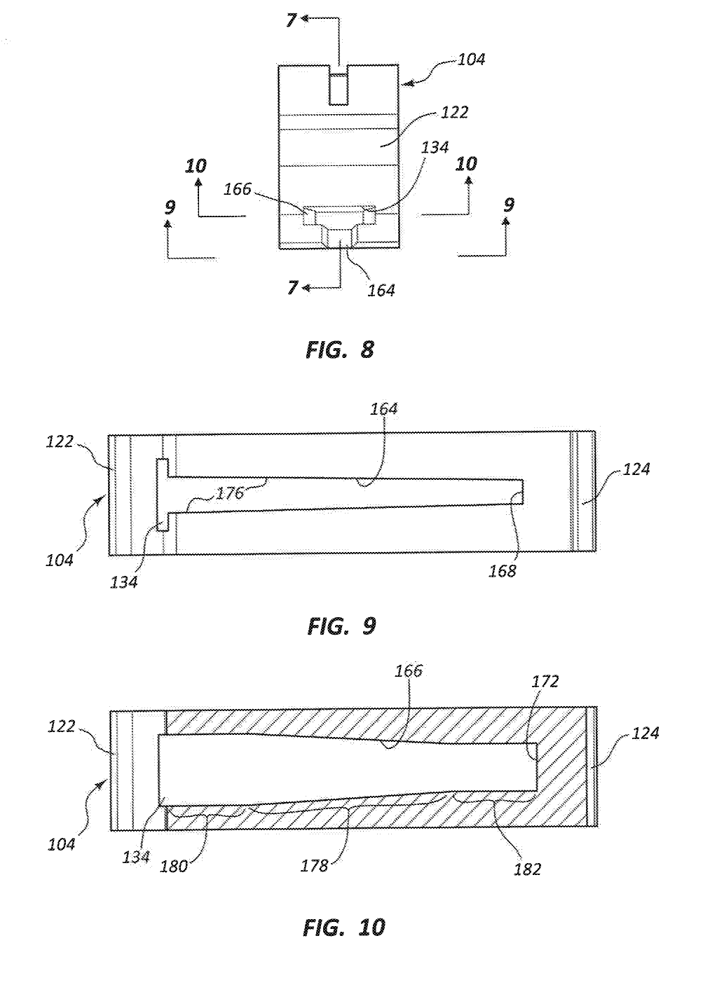

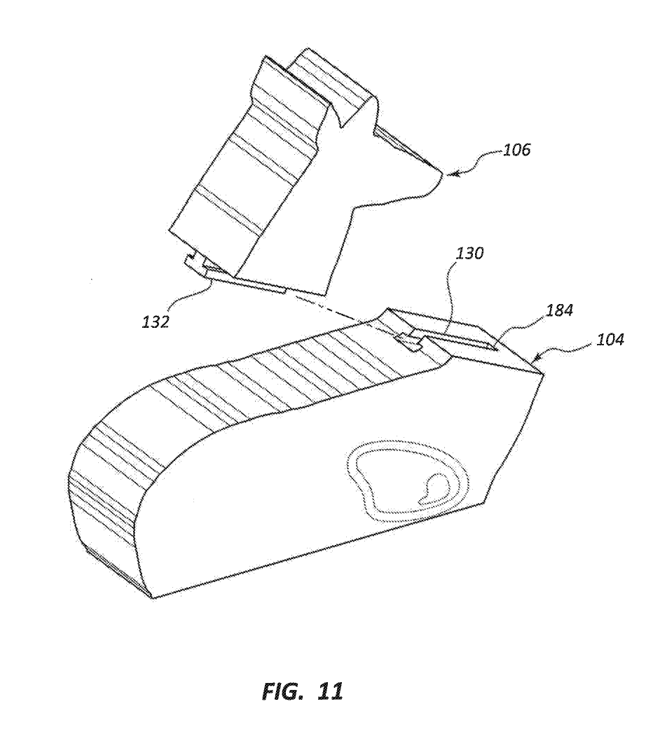

The leg portion 102 may comprise a ridge 126 configured to be inserted into a groove 128 on the body portion 104. The ridge 126 and groove 128 are shown and described in greater detail in connection with FIGS. 3-10. The body portion 104 may also comprise an upper groove 130 configured to receive an upper ridge 132 on the head portion 106. See FIG. 11 and its related description herein.

The target assembly 100 is shown having a three-dimensional shape similar to a deer. Those having ordinary skill in the art will also readily recognize that the shape of the target assembly 100 may alternatively be a profile shape of other game animals, such as, for example, an elk, antelope, bighorn sheep, elephant, bear, turkey, moose, bison, goat, bobcat, cougar, a different deer, or other comparable animal. Thus, the shape of the present target assembly 100 is intended to be illustrative of one example shape that the target assembly 100 can have without being limiting solely to the pictured shape.

To assemble the target assembly 100, the user may insert the ridge 126 of the leg portion 102 into the groove 128 of the body portion 104 and insert the head portion 106 into the upper groove 130 on the body portion 104. The leg portion 102 may also optionally be attached to the stand 108. The ridge 126 may be inserted longitudinally into the groove 128. For example, the groove 128 may comprise an open end 134 that is open horizontally relative to the body portion 104, and the ridge 126 may slide into the open end 134 until it reaches the position shown in FIG. 1. With the leg portion 102 and body portion 104 thus connected to each other, they may be easily and simultaneously moved around without falling apart. This feature may be advantageous when a user assembles the leg portion 102 and body portion 104 while the parts are lying down on their lateral sides (e.g., 136, 138) and then needs to move the assembled parts onto the stakes or stand 108. When the ridge 126 and groove 128 are interlocked as described above, the leg and body portions 102, 104 do not slide relative to each other in a vertical direction and have little or no sliding relative to each other in a horizontal direction. Thus, the portions are solidly held together upon assembly and can be moved as if they were a single integral piece.

At least one of the lateral sides 136, 138 may be designated as a target surface 139 of the target assembly 100. A target surface 139 may comprise a surface on the target assembly 100 that is the objective target for the shooter. In other words, the target surface is the surface of the target assembly 100 that the shooter aims toward and intends to accurately shoot. The target surface 139 may include target markings such as, for example, a concentric circle pattern or a pattern imitating the shape and/or positioning of vital organs of an animal being represented by the target assembly 100. The pattern shown in FIG. 1 is an example of a target pattern that may be shown on the target surface 139 of the target assembly. The target pattern may be shown on the leg portion 102 and/or the body portion 104. It may be advantageous to have the target pattern shown on only one of the leg or body portions 102, 104 when one of the portions comprises a more durable and tear-resistant material than the other. Thus, the shooter is encouraged to shoot at the most durable portion of the target assembly 100. Additionally, the positioning of the target pattern may encourage shooters to aim at portions of the target assembly 100 that are less likely to cause damage to the ridge 126 and/or groove 128, such as a target pattern that encourages shooters to aim higher than the ridge 126 and groove 128.

FIGS. 3-6 show various views of the leg portion 102 of an embodiment of the present disclosure. The leg portion 102 may comprise a plurality of legs 140 and a connecting portion or belly portion 142. The legs 140 may be positioned at the front and rear ends 118, 120 of the leg portion 102. The belly portion 142 may horizontally link the plurality of legs 140 to each other. The belly portion 142 may comprise a top surface 144 configured to face upward when the target assembly 100 is upright, and the ridge 126 may extend across the top surface 144. The top surface 144 may be angled relative to a horizontal direction, such as having a decline of angle A wherein the front end portion 118 is slightly higher than the rear end portion 120. The angle A may be less than about 5 degrees. Thus, the top surface 144 may be substantially horizontally oriented, but may also facilitate removal of the body portion 104 from the top of the leg portion 102 due to the decline gravitationally biasing the body portion 104 toward the rear end 120 of the leg portion 102 when the body portion 104 is on top of the leg portion 102.

The ridge 126 may comprise a vertical portion 146 and a horizontal portion 148. The vertical portion 146 may extend vertically upward from the top surface 144 of the leg portion 102, and the horizontal portion 148 may be positioned on top of the vertical portion 146. The horizontal and vertical portions 148, 146 may collectively form a T-shaped profile. See FIG. 4. Alternatively, the horizontal and vertical portions 148, 146 may form a Y-shaped profile, L-shaped profile or other shape having at least one horizontal component and at least one vertical component. Some of the ridge 126, such as the horizontal portion 148, may thus be spaced away from the top surface 144 of the leg portion 102 by the vertical portion 146. In other words, some of the horizontal portion 148 may have a surface facing downward toward the top surface 144 of the leg portion 102. Accordingly, the space between the horizontal portion 148 and the top surface 144 may allow portions of the body portion 104 of the target assembly 100 to be inserted and positioned between the horizontal portion 148 and the top surface 144. With portions of the body portion 104 between the top surface 144 and the horizontal portion 148, the body portion 104 may be interlocked with the ridge 126 and may therefore be inhibited from being pulled upward away from the top surface 144.

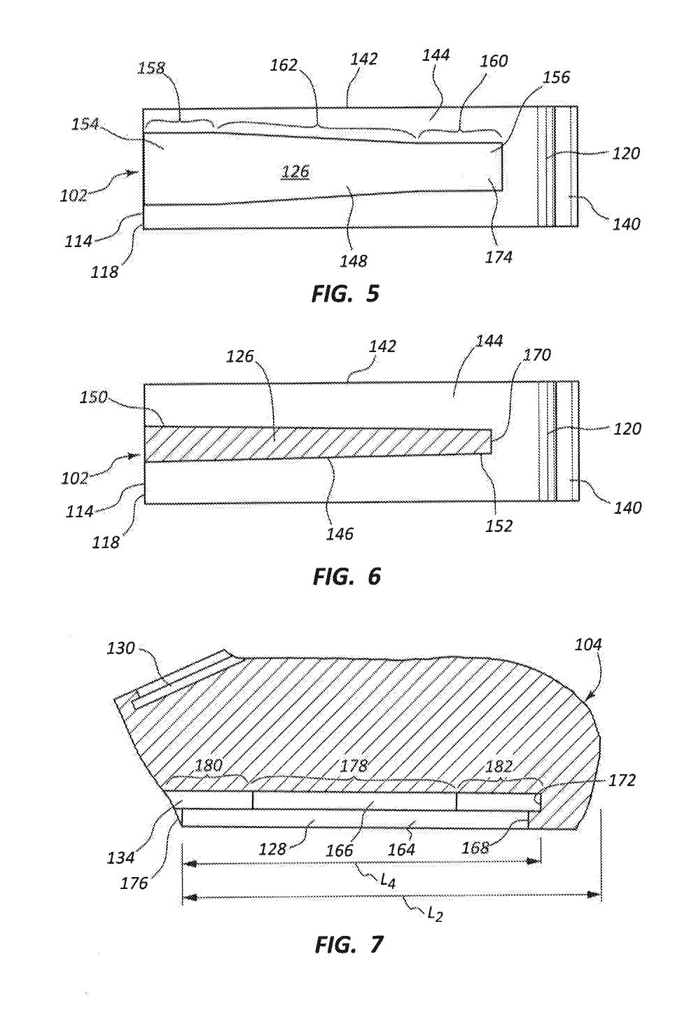

The vertical portion 146 of the ridge 126 may comprise a front end 150 and a rear end 152. See FIG. 6. The front end 150 may be broader in width than the rear end 152. Thus, the ridge 126 may have a vertical portion 146 that is tapered down from the front end 150 toward the rear end 152. The horizontal portion 148 may also comprise a front end 154 and a rear end 156, wherein the front end 154 is broader than the rear end 156. See FIG. 5. The horizontal portion 148 may comprise a front straight portion 158 and a rear straight portion 160 separated from each other by a tapered portion 162. Thus, the horizontal portion 148 may be tapered along at least a portion of its overall length, wherein the portion that is tapered (i.e., the tapered portion 162) is spaced away from the extreme front and rear ends of the ridge 126 by straight portions 158, 160. As discussed in further detail below, the tapered features of the ridge 126 may facilitate retention of the ridge 126 within the groove 128 when the target is assembled. Having straight portions 158, 160 may help facilitate a better press-fit between the leg portion 102 and body portion 104 due to the ridge 126 being slightly wider than the groove 128 at corresponding portions of the groove 128.

The ridge 126 may have a length L₃ extending along substantially the entire length L₁ of the leg portion 102. In some embodiments, the ridge 126 may continuously extend across more than half of the length L₁ of the leg portion 102, such as, for example, about 60 percent of the length, about 70 percent of the length, about 80 percent of the length, or about 90 percent of the length. In other embodiments, the length L₃ of ridge 126 may extend across the entire length L₁ of the leg portion 102. Similarly, the length L₄ of groove 128 may extend along substantially the entire length L₂ of the body portion 104. See FIG. 7. In some arrangements the ridge 126 may continuously extend across more than half of the length L₂, such as, for example, about 60 percent of the length, about 70 percent of the length, about 80 percent of the length, or about 90 percent of the length.

In some embodiments, the ridge 126 may be a single integral piece extending along its entire length rather than being formed as multiple consecutive spaced apart ridges. Accordingly, the ridge 126 may be easier to construct, and it may be easier to assess and fix any damage it may take. Also, because the ridge 126 extends along a substantial portion of the overall length of the leg portion 102, the ridge 126 may provide connection to the body portion 104 along a large portion of the length of the body portion, thereby reducing the possibility of the body portion 104 twisting or rotating relative to the leg portion 102. The size of the ridge 126 may also correlate with having a large contact surface area between the ridge 126 and the groove 128. With a large contact surface area, the friction between the leg portion 102 and body portion 104 may be proportionally large, so it is less likely that there will be unintentional disconnection or falling apart of the target assembly 100. Furthermore, a large ridge 126 may help maintain connection with the body portion 104 as the target assembly 100 ages or takes damage. If portions of the ridge 126 are damaged or deteriorate (e.g., portions near the area on the target assembly 100 that is shot at the most), the rest of the ridge 126 may still help keep the target assembly 100 from falling apart or becoming disjointed.

FIGS. 7-10 illustrate various views of the body portion 104 of the target assembly 100. The groove 128 in the body portion 104 may extend along a substantial portion of the entire length L₂ of the body portion 104. Thus, the groove 128 may have a length L₄ about the equal to the length L₃ of the ridge 126. The groove 128 may also have about the same width as the ridge 126, wherein a vertical portion 164 of the groove 128 may be about the same width as the vertical portion 146 of the ridge 126, and a horizontal portion 166 of the groove 128 may be about the same width as the horizontal portion 148 of the ridge 126. Accordingly, the ridge 126 and groove 128 may have corresponding sizes that allow the ridge 126 to be laterally enclosed within in the groove 128 by sliding into the groove 128 from the open end 134 of the groove 128.

The groove 128 may also comprise a rear surface 168. The rear surface 168 may be positioned at the terminal end of the groove 128 that is opposite the open end 134. The rear surface 168 may be oriented substantially perpendicular to the length of the groove 128 and may be positioned at the rear end portion 124 of the body portion 104. When the ridge 126 is completely inserted into the groove 128, the ridge 126 may have a rear surface 170 that contacts the rear surface 168 of the groove 128. See FIGS. 3-4. When the ridge 126 is inserted into the groove 128, the contact between the rear surfaces 168, 170 may prevent the ridge 126 from sliding any further through the body portion 104 due to abutting and being seated against the rear surface 168 of the groove 128. The presence of the rear surface 168 causes the rear end portion 124 of the body portion 104 to be closed from a horizontal direction. In other words, the groove 128 is not accessible from a horizontal direction at the rear end portion 124 of the body portion 104. The ridge 126 must be inserted from the opposite end of the groove 128 since there is an open end 134 there.

The groove 128 may also comprise a rear recess 172 into which a rear extension 174 of the ridge 126 may be positioned. See FIGS. 3 and 7. When the rear extension 174 is positioned in the rear recess 172, the ridge 126 may be even more securely held in place within the body portion 104 since the rear extension 174 may contact inside surfaces of the rear recess 172 and thereby prevent rotation of the rear end of the ridge 126 out of the rear end of the groove 128, even if some other laterally-extending horizontal portion 148 of the ridge 126 is damaged or missing.

The vertical portion 164 of the groove 128 may comprise tapered sidewalls 176, and the horizontal portion 166 of the groove 128 may comprise a tapered portion 178 positioned between a front straight portion 180 and a rear straight portion 182. See FIGS. 9-10. Thus, the inner lateral-facing surfaces of the groove 128 may have shapes corresponding with the outward lateral-facing surfaces of the ridge 126.

When the ridge 126 is horizontally inserted into the groove 128, the rear straight portion 160 of the ridge 126 may pass through the front straight portion 180 of the groove 128, through the tapered portion 178, and into the rear straight portion 182. The rear straight portion 182 of the groove 128 and the rear straight portion 160 of the ridge 126 may have similar widths. Accordingly, there may be no resistance against movement of the ridge 126 into the groove 128 until the rear straight portions 160, 182 engage each other. Because there is no resistance for a large portion of the length of the ridge 126 and groove 128, it may be easier to move the ridge 126 into the groove 128 than if their entire lengths frictionally engaged each other. The last part of the insertion before complete insertion (i.e., when the rear straight portions 160, 182 are engaging each other and the front straight portions 158, 180 are engaging each other as the ridge 126 moves fully into the groove 128) may present increased frictional resistance, and once the ridge 126 is completely inserted into the groove 128, frictional engagement between the rear straight portions 160, 182 and the front straight portions 158, 180 may keep the leg portion 102 fixed to the body portion 104 so that they are not freely slidable relative to each other. It may be advantageous to have front straight portions and rear straight portions that simultaneously engage each other so that one of the sets of straight portions may keep the leg and body portions 102, 104 engaged even if there is damage or breakage of one of the two straight portions.

In some embodiments, the rear straight portion 182 of the groove 128 may have a slightly narrower width than the width of the rear straight portion 160 of the ridge 126 and the front straight portion 180 of the groove 128 may have a slightly narrower width than the width of the front straight portion 158 of the ridge 126. Accordingly, the corresponding straight portions may have a frictional fit with each other. At least one of the ridge 126 and groove 128 may comprise a compressible material, and the ridge 126 and/or groove 128 may compress to apply pressure between the corresponding front and rear straight portions. A friction or compression fit between the parts may allow the leg portion 102 and body portion 104 to be reversibly and releasably attached to each other, wherein they can be connected and held together without the use of adhesives, fasteners, or welding.

FIG. 11 illustrates an exploded view of the upper section of the target assembly 100 that shows the upper ridge 132 on the head portion 106 and the upper groove 130 on the body portion 104. The upper ridge 132 and upper groove 130 may have interlocking T-shaped profiles similar to the groove 128 and ridge 126. The upper ridge 132 may slide into the upper groove 130 and may be held therein by a friction fit between the upper ridge 132 and upper groove 130. The head portion 106 may also be held in place by gravity drawing the head portion 106 downward so that the upper ridge 132 remains seated in the upper groove 130. The upper ridge 132 may slide until it contacts the end surface 184 of the upper groove 130 where it is prevented from sliding further downward.

Another aspect of the present disclosure relates to methods of constructing or assembling an archery target. One example embodiment of such a method may comprise providing a first target body, a second target body, and a stand. The first target body may comprise a first length and an elongated ridge, and the second target body may comprise a second length and an elongated groove. The first and second lengths may be substantially equal. The elongated ridge may have a ridge length substantially equal to the first length, and the elongated groove may have a groove length substantially equal to the second length. The method may further comprise inserting the elongated ridge on the first target body into the elongated groove on the second target body. Inserting the elongated ridge into the elongated groove may comprise sliding the ridge into the groove. The lateral side surfaces of the ridge and groove may contact each other in the process.

The method may further comprise positioning the first and second target bodies upright, wherein at least one of the first and second target bodies is positioned on the stand. The first and second target bodies may be vertically stacked on each other above the stand. FIG. 1 illustrates an example wherein target bodies (e.g., leg portion 102 and body portion 104) are vertically stacked on top of each other above a stand (e.g., stand 108) and connected to the stand.

In these methods, the elongated ridge may be inserted into the elongated groove in a horizontal direction. For example, the elongated ridge may be inserted into the elongated groove starting with a rear end of the ridge being inserted into a front end of the groove and then sliding the ridge and groove relative to each other along a longitudinal axis running between the front and rear ends until the rear end of the ridge is adjacent to or abutting the rear end of the groove.

In some embodiments, the stand may be mounted to a ground surface. For example, this may comprise the stand 108 being supported by a flat, horizontal surface. The stand may be anchored to the ground surface. For example, the stand may comprise a plurality of stakes that are anchored in the ground surface and that extend into engagement with one of the first and second target bodies. The stand may also comprise horizontal portions (e.g., 112) that provide angular stability to the target assembly.

Another embodiment of the methods may comprise compressing at least one of the elongated ridge and the elongated groove while inserting the elongated ridge on the first target body into the elongated groove on the second target body. Thus, the ridge, the groove, or both, may compress when the ridge and groove are brought into engagement with each other.

In another embodiment, the first and second target bodies collectively form the shape of an animal, such as one of the animals described elsewhere herein. Accordingly, the first or second target body may each correspond to the legs/lower body of the animal, and the other target body may correspond to the shoulders/back/upper body of the animal. At least one of the target bodies may comprise a face positioned on the animal where vital organs of the animal would be located.

The method may comprise another step of lifting at least one of the first and second target bodies with the first and second target bodies being positioned upright. The elongated groove and elongated ridge may remain stationary relative to each other while lifting. The groove and ridge may not slide relative to each other while lifting in a vertical direction since they are stacked on top of each other. The archery target may be supported at the front and rear ends, but the first and second target bodies may not shift vertically relative to each other when the target is lifted. Other conventional targets are vertically divided between the front end rear ends, so a similar lifting motion could allow the target to slip apart at the vertical division.

The methods may also comprise attaching a third target body to one of the first and second target bodies, wherein the third target body extends vertically higher than the first and second target bodies. The third target body may comprise, for example, a head and neck portion of an animal shape.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

1. An archery target assembly, comprising:
a first target body having a first width, a first front surface, and a first rear surface, the first width extending from the first front surface to the first rear surface;
a second target body having a second width, a second front surface, a second rear surface, a bottom portion, and a target surface, the second width extending from the second front surface to the second rear surface, the first target body contacting the bottom portion of the second target body, the first and second widths being about equal to each other, the first target body being slidably separable from the second target body along a horizontal direction.

2. The archery target assembly of claim 1, wherein the first and second target bodies are connected to each other using an elongated ridge engaging an elongated groove, wherein the elongated ridge and elongated groove are each elongated in the horizontal direction.

3. The archery target assembly of claim 2, wherein the elongated ridge and the elongated groove each comprise a T-shaped cross-section.

4. The archery target assembly of claim 1, wherein the first target body comprises a first material and the second target body comprises a second material, the second material being more flexible than the first material.

5. The archery target assembly of claim 1, further comprising a rod, the rod connected to the first target body and configured to keep the first target body upright.

6. The archery target assembly of claim 1, wherein the first and second widths are horizontally-oriented when the archery target assembly is in an upright position.

7. The archery target assembly of claim 1, wherein the first and second target bodies are press-fit into engagement with each other.

8. The archery target assembly of claim 1, wherein at least one of the first and second target bodies is compressed against the other.

9. The archery target assembly of claim 1, further comprising a third target body, the third target body being attached to a side or top portion of the second target body.

10. An archery target assembly, comprising:
a first target body shaped as a lower portion of an animal, the first target body having a first front end surface, a first rear end surface, and an elongated ridge extending between the first front end surface and the first rear end surface;
a second target body shaped as an upper portion of the animal, the second target body having a second front end surface, a second rear end surface, and an elongated groove extending between the second front end surface and the second rear end surface;
wherein the first target body is positioned underneath the second target body, the first and second front end surfaces being adjacent each other, the first and second rear end surfaces being adjacent each other, the elongated ridge being positioned within the elongated groove.

11. The archery target assembly of claim 10, wherein the elongated groove and the elongated ridge are configured to extend in a substantially horizontal direction.

12. The archery target assembly of claim 10, wherein the elongated groove and elongated ridge each have a length extending substantially from the front end to the rear end of the first and second target bodies.

13. The archery target assembly of claim 10, wherein the elongated ridge comprises a vertical ridge portion and a horizontal ridge portion and the elongated groove comprises a vertical groove portion and a horizontal groove portion, the vertical ridge portion being positioned in the vertical groove portion and the horizontal ridge portion being positioned in the horizontal groove portion.

14. The archery target assembly of claim 10, wherein at least one of the elongated ridge and the elongated groove is tapered along a horizontal direction.

15. The archery target assembly of claim 10, wherein the elongated groove is open from the horizontal direction at the front end of the second target body and the elongated groove is inaccessible from a horizontal direction at the rear end of the second target body.

16. A method of constructing an archery target, the method comprising:
providing a first target body, a second target body, and a stand, the first target body having a first overall length and an elongated ridge, the second target body having a second overall length and an elongated groove, the first and second overall lengths being substantially equal, the elongated ridge having a ridge length substantially equal to the first overall length, the elongated groove having a groove length substantially equal to the second overall length;
inserting the elongated ridge on the first target body into the elongated groove on the second target body;
positioning the first and second target bodies upright, wherein at least one of the first and second target bodies is positioned on the stand, the first and second target bodies being vertically stacked on each other above the stand.

17. The method of claim 16, wherein the elongated ridge is inserted into the elongated groove in a horizontal direction.

18. The method of claim 16, wherein the stand is mounted to a ground surface.

19. The method of claim 16, further comprising compressing at least one of the elongated ridge and the elongated groove while inserting the elongated ridge on the first target body into the elongated groove on the second target body.

20. The method of claim 16, further comprising lifting at least one of the first and second target bodies with the first and second target bodies being positioned upright, wherein the elongated groove and elongated ridge remain stationary relative to each other while lifting.

21. The method of claim 16, further comprising attaching a third target body to one of the first and second target bodies, the third target body extending vertically higher than the first and second target bodies.
